(19) United States
(12) Patent Application Publication
(10) Pub. No.: US 2015/0221936 A1
(43) Pub. Date: Aug. 6, 2015

(54) NEGATIVE ELECTRODE MATERIAL FOR A LITHIUM ION BATTERY

(71) Applicant: GM GLOBAL TECHNOLOGY OPERATIONS LLC, Detroit, MI (US)

(72) Inventor: Xiaosong Huang, Novi, MI (US)

(73) Assignee: GM GLOBAL TECHNOLOGY OPERATIONS LLC, Detroit, MI (US)

(21) Appl. No.: 14/173,560

(22) Filed: Feb. 5, 2014

(51) Int. Cl. H01M 4/36; H01M 4/38; H01M 4/04; H01M 4/62

(52) U.S. Cl. CPC H01M 4/366; H01M 4/622; H01M 4/386; H01M 4/0402; H01M 4/049; H01M 4/0471

(57) ABSTRACT

A negative electrode material includes an active material particle. The active material particle includes a silicon core and an oxidation layer on a surface of the silicon core. The negative electrode material further includes a polyimide binder bound directly to the oxidation layer of the active material particle. An additional binding enhancing agent is excluded from the negative electrode material.

### BACKGROUND

Secondary, or rechargeable, lithium ion batteries are often used in many stationary and portable devices, such as those encountered in the consumer electronic, automobile, and aerospace industries. The lithium class of batteries has gained popularity for various reasons, including a relatively high energy density, a general nonappearance of any memory effect when compared to other kinds of rechargeable batteries, a relatively low internal resistance, and a low self-discharge rate when not in use. The ability of lithium batteries to undergo repeated power cycling over their useful lifetimes makes them an attractive and dependable power source.

### SUMMARY

An example of a negative electrode material includes an active material particle. The active material particle includes a silicon core and an oxidation layer on a surface of the silicon core. The negative electrode material further includes a polyimide binder bound directly to the oxidation layer of the active material particle. An additional binding enhancing agent is excluded from the negative electrode material.

The negative electrode may be included in a negative electrode for a lithium ion battery.

### BRIEF DESCRIPTION OF THE DRAWINGS

Features and advantages of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a cross-sectional view of an example of a negative electrode on a current collector;

FIG. 2 is a perspective schematic view of an example of a lithium ion battery, including an example of the negative electrode disclosed herein; and

FIG. 3 is a graph exhibiting the specific capacity versus cycle number for an example of the negative electrode disclosed herein.

### DETAILED DESCRIPTION

The high theoretical capacity (e.g., 4200 mAh/g) of silicon renders it desirable for use as a negative electrode material in lithium ion batteries. However, it has been found that negative electrode materials (e.g., silicon particles) with high specific capacities also have large volume expansion and contraction during charging/discharging of the lithium ion battery. The large volume change (e.g., about 300%) experienced by the negative electrode material during charging/discharging causes the negative electrode material to fracture, decrepitate, or otherwise mechanically degrade, which results in a loss of electrical contact and poor life cycling. Poor cycling performance often includes a large capacity fade, which may result from the breakdown of contact between the negative electrode material and conductive fillers in the negative electrode due to the large volume change.

The negative electrode material includes an active material particle, which is made up of a silicon core and an oxidation layer on the surface of the silicon core. The negative electrode material further includes a polyimide binder that forms an interfacial bond with the oxidation layer. This interfacial bond ensures that the binder remains adhered to the active material particle and also ensures that the active material particle remains in contact with conductive filler(s) and current collector(s). As such, the interfacial bond also contributes to better cycling performance and electrode integrity.

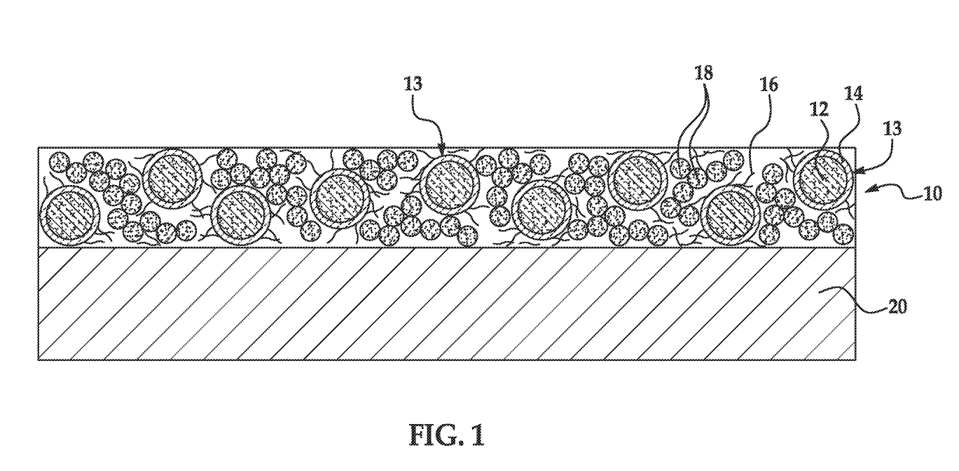

Referring now to FIG. 1, an example of a negative electrode 10 on a negative-side current collector 20 is depicted. It is to be understood that the negative electrode 10 is made up of the negative electrode material, which includes, in this example, the active material particle 13, the polyimide binder 16, and a conductive filler 18. An example of a method for making the negative electrode material and the negative electrode 10 will be also discussed in reference to FIG. 1.

As mentioned above and as shown in FIG. 1, the active material particle 13 includes the silicon particle 12 as its core (and thus also referred to herein as the silicon core 12), and the oxidation layer 14 as a shell, coating a surface of the silicon particle 12. In an example, the silicon particle 12 is a silicon powder (e.g., silicon micro- or nano-powders). It is to be understood, however, that the silicon core 12 may be in the form of a silicon nanotube, a silicon nanofiber, etc. In an example, the grain/particle size of the silicon particle/core 12 may range from about 1 nm to about 20 μm.

To form the oxidation layer 14 on the silicon particle 12, the surface of the silicon particle 12 may be oxidized. Oxidation of the silicon particle surface may be accomplished by exposing the silicon particle 12 to an environment that contains oxygen for at least 1 hour. In an example, the oxidation of the silicon particle surface may be accomplished by exposing the silicon particle 12 to air for a time period ranging from about 5 hours to about 30 days. Oxidation converts the silicon present at least at the surface of the silicon particle 12 into oxidized silicon, SiOₓH_{y}, where each of x and y can range from 0 to 4. Oxidation forms the oxidation layer 14 as a coating on the silicon particle 12. In an example, the silicon reacts with water in the air to form Si—OH during oxidation.

It is to be understood that the thickness (measured from the surface of the silicon particle 12 in towards the center of the silicon particle 12) of the oxidation layer 14 that is formed will depend, at least in part, on the time for which the silicon particle 12 is exposed to the air, the temperature of the air, and the humidity in the air. The thickness may be uniform, or may vary. In general, the thickness will increase as the exposure time, and/or the temperature, and/or the humidity increases. The temperature may range from room temperature (e.g., from about 18° C. to about 22° C.) to about 100° C. The humidity may range from about 20% relative humidity (R.H.) to about 100% R.H. As an example, to obtain a 1 nm thickness increase, the exposure time may range anywhere from 1 day to 30 days. In the examples disclosed herein, the thickness of the oxidation layer 14 is 20 nm or less. As specific examples, the thickness of the oxidation layer 14 may range from about 0.1 nm to about 10 nm, or from about 0.1 nm to about 5 nm.

The thickness of the oxidation layer 14 may also depend upon the types of silicon particle 12 that is used. For example, the rate at which the oxidation layer is formed will be different for crystalline silicon and amorphous silicon, although these rates are likely on the same order of magnitude. Furthermore, a smaller particle may have a higher rate than a larger particle.

The polyimide binder 16 disclosed herein may be formed from the imidization of a polyimide pre-polymer, namely poly(amic acid). The polyimide pre-polymer may be formed in solution, which includes a dianhydride and a diamine in a polar aprotic solvent. The dianhydride is in a slight stoichiometric excess of the diamine. In an example, the stoichiometric excess of the dianhydride (relative to the diamine) ranges from about 0.01% to about 5%. As will be discussed further hereinbelow, the excess dianhydride provides additional anhydride groups that can react with hydroxyl group(s) on the oxidation layer 14.

Some examples of the dianhydride have an electron-withdrawing group, such C═O or SO₂. Examples of these include the following:

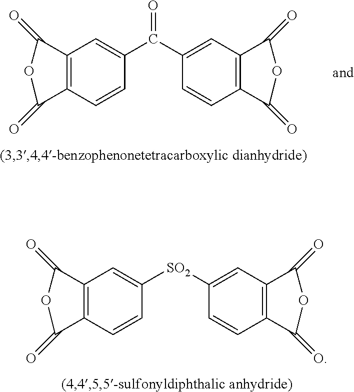

Other examples of the dianhydride do not include an electron-withdrawing group. Examples of these include the following:

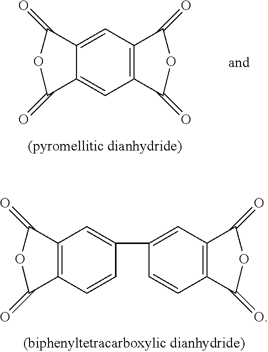 [SMILES: O=c1oc(=O)c2cc3c(=O)oc(=O)c3cc12 ; O=C1OC(=O)c2cc(-c3ccc4c(c3)C(=O)OC4=O)ccc21]

In the examples disclosed herein, the diamine contains no more than two ether groups. Examples of suitable diamines include toluene diamine, p-phenylenediamine, 4,4′-diaminophenylether, and diaminodiphenylmethane.

Examples of suitable polar aprotic solvents include dimethylacetamide (DMAc), N-methyl-2-pyrrolidone (NMP), dimethylformamide (DMF), dimethylsulfoxide (DMSO), or another Lewis base, or combinations thereof.

The diamine and the stoichiometric excess of dianhydride are added to the polar aprotic solvent to form a polyimide pre-polymer solution. The polyimide pre-polymer solution may be kept at a temperature ranging from about 0° C. to about ambient/room temperature (e.g., from about 18° C. to about 22° C.). Within the polyimide pre-polymer solution, the intermediate or pre-polymer, poly(amic acid), forms due to the nucleophilic attack of the amino group(s) of the diamine on the carbonyl carbon of some of the anhydride group(s) of the dianhydride. The amount of solvent used in the solution may vary, depending upon the amounts of diamine and dianhydride that are used. In an example, the final solution includes from about 5 wt % to about 50 wt % of the poly(amic acid), and a remaining balance of the solvent.

A slurry is formed by adding the active material particles 13 to the polyimide pre-polymer solution.

The conductive filler 18 may also be added to the slurry. The conductive filler 18 may be a high surface area carbon, such as acetylene black. Other examples of suitable conductive fillers include graphene, carbon nanotubes, and/or carbon nanofibers. The conductive filler 18 is included to ensure electron conduction between a negative-side current collector (i.e., support 20) and the active material particles 13.

In an example then, the slurry includes the polar aprotic solvent, water, the polyimide pre-polymer, the active material particles 13, and the conductive filler 18. In one example of the slurry, the amount of the active material particles 13 ranges from about 30 wt % to about 95 wt % (based on total wt % of solid material), the amount of the conductive filler 18 ranges from about 5 wt % to about 50 wt % (based on total wt % of solid material), and the amount of the polyimide pre-polymer ranges from about 5 wt % to about 60 wt % (based on total wt % of solid material). In another example of the slurry, the amount of the active material particles 13 ranges from about 30 wt % to about 80 wt %, the amount of the conductive filler 18 ranges from about 10 wt % to about 50 wt %, and the amount of the polyimide pre-polymer ranges from about 5 wt % to about 40 wt %.

The slurry may be mixed, and then deposited onto a support 20. In an example, the support 20 is a negative-side current collector. It is to be understood that the support 20 may be formed from copper or any other appropriate electrically conductive material known to skilled artisans. The support 20 that is selected should be capable of collecting and moving free electrons to and from an external circuit connected thereto.

The slurry may be deposited using any suitable technique. As examples, the slurry may be cast on the surface of the support 20, or may be spread on the surface of the support 20, or may be coated on the surface of the support 20 using a slot die coater.

The deposited slurry may be exposed to a drying process in order to remove any remaining solvent and/or water. Drying may be accomplished using any suitable technique. Drying may be performed at an elevated temperature ranging from about 60° C. to about 150° C. In some examples, vacuum may also be used to accelerate the drying process. As one example of the drying process, the deposited slurry may be exposed to vacuum at about 120° C. for about 12 to 24 hours.

The drying process results in a coating formed on the surface of the supports 20. In an example, the thickness of the dried slurry (i.e., coating) ranges from about 5 μm to about 500 μm.

The dried slurry (i.e., coating) on the support 20 is then exposed to a heat treatment to initiate, complete, and/or improve i) the degree of imidization of the polyimide pre-polymer and ii) the reaction between the oxidation layer 14 and the polyimide pre-polymer. As such, during the heat treatment, multiple reactions take place. First, the pre-polymer is polymerized to form polyimide (i.e., the polyimide binder 16). Second, at least some of the anhydride groups of the pre-polymer react with at least some of the hydroxyl groups of the oxidation layer 14 to form interfacial bonds therebetween. This results in at least some of the polyimide binder 16 being bound to at least some of the surface active particle(s) 13. Since a bond is formed directly between the active material particle(s) 13 and the polyimide binder(s) 16, an additional binding enhancing agent (e.g., polyvalent carboxylic acid or its derivatives or polyvalent amine) is not added to the negative electrode 10.

The heat treatment of the deposited and dried slurry may be performed at a temperature ranging from about 180° C. to about 400° C. In any of the examples disclosed herein, the heat treatment may be performed under the protection of vacuum or an inert gas (e.g., nitrogen, argon, etc.). As examples, the heat treatment may be performed in an oven, or using a microwave and thermal treatment. The time for heat treating may depend upon the chemistry of the polyimide pre-polymer, and in general ranges from about 1 hour to about 20 hours.

In an example, heat treating is performed at a constant temperature for some determined time period. For an example, heating treatment may be performed in an oven under nitrogen gas at about 250° C. for about 2 hours. For another example, a microwave and thermal treatment may be performed at about 250° C. for about 30 minutes.

In another example, heat treating is performed using a temperature ramp, where the temperature is increased over time at determined or preset intervals. As an example, the deposited and dried slurry may be initially heated at 180° C. for about 2 hours, and then the temperature may be raised to about 250° C. The deposited and dried slurry may be heated at the 250° C. temperature for about 2 hours, and then the temperature may be raised to about 300° C. The deposited and dried slurry may be heated at the 300° C. temperature for about 2 hours, and then the temperature may be raised to about 350° C., at which temperature the deposited and dried slurry may be heated for at least another 2 hours.

Heat treating forms the negative electrode 10, which includes the conductive filler 18, the active material particles 13, and the polyimide binder 16 (at least some of which is bound to at least some of the active material particles 13). The loading of the respective negative electrode components may include: from about 30 wt % to about 95 wt % (based on the total wt % of the negative electrode 10) of the active material particles 13, from about 5 wt % to about 50 wt % of the conductive filler 18, and from about 5 wt % to about 60 wt % of the polyimide binder 16.

In some examples, the negative electrode 10 may be paired with a lithium electrode. In an example, the negative electrode 10 including the silicon-containing active material particles 13 may be paired with lithium metal to form a half-cell.

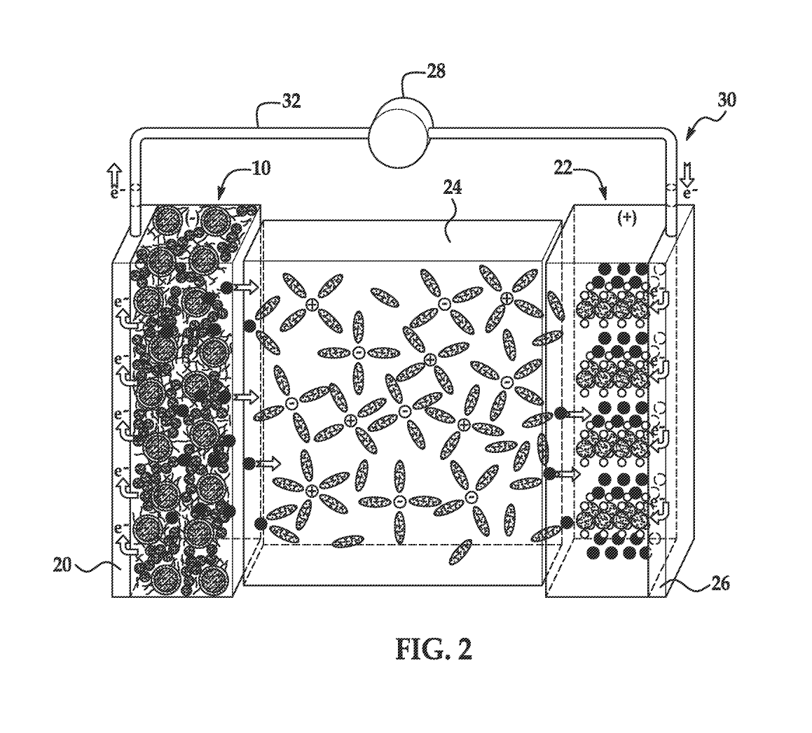

The active material particles 13 of the negative electrode 10 can sufficiently undergo lithium insertion and deinsertion. As such, the negative electrode 10 formed on the support 20 (negative-side current collector) may be used in a lithium ion battery 30. An example of the lithium ion battery 30 is shown in FIG. 2.

As depicted in FIG. 2, the lithium ion battery 30 includes the negative electrode 10, the negative side current collector 20, a positive electrode 22, a positive-side current collector 26, and a porous separator 24 positioned between the negative electrode 10 and the positive electrode 22.

The positive electrode 22 may be formed from any lithium-based active material that can sufficiently undergo lithium insertion and deinsertion while functioning as the positive terminal of the lithium ion battery 30. One common class of known lithium-based active materials suitable for the positive electrode 22 includes layered lithium transitional metal oxides. Some specific examples of the lithium-based active materials include spinel lithium manganese oxide (LiMn₂O₄), lithium cobalt oxide (LiCoO₂), a nickel-manganese oxide spinel [Li(Ni_{0.5}Mn_{1.5})O₂], a layered nickel-manganese-cobalt oxide [Li(NiₓMn_{y}Co_{z})O₂], or a lithium iron polyanion oxide, such as lithium iron phosphate (LiFePO₄) or lithium iron fluorophosphate (Li₂FePO₄F). Other lithium-based active materials may also be utilized, such as lithium nickel-cobalt oxide (LiNiₓCo₁₋ₓO₂), aluminum stabilized lithium manganese oxide spinel (LiₓMn₂₋ₓAl_{y}O₄), and lithium vanadium oxide (LiV₂O₅).

The lithium-based active material of the positive electrode 22 may be intermingled with a polymeric binder and a high surface area carbon. Suitable binders include polyvinylidene fluoride (PVdF), an ethylene propylene diene monomer (EPDM) rubber, and/or carboxymethyl cellulose (CMC)). The polymeric binder structurally holds the lithium-based active materials and the high surface area carbon together. An example of the high surface area carbon is acetylene black. The high surface area carbon ensures electron conduction between the positive-side current collector 26 and the active material particles of the positive electrode 22.

The positive-side current collector 26 may be formed from aluminum or any other appropriate electrically conductive material known to skilled artisans.

The porous separator 24, which operates as both an electrical insulator and a mechanical support, is sandwiched between the negative electrode 10 and the positive electrode 22 to prevent physical contact between the two electrodes 10, 22 and the occurrence of a short circuit. In addition to providing a physical barrier between the two electrodes 10, 22, the porous separator 24 ensures passage of lithium ions (identified by the black dots and by the open circles having a (+) charge in FIG. 2) and related anions (identified by the open circles having a (−) charge in FIG. 1) through an electrolyte solution filling its pores. This helps ensure that the lithium ion battery 30 functions properly.

The porous separator 24 may be a polyolefin membrane. The polyolefin may be a homopolymer (derived from a single monomer constituent) or a heteropolymer (derived from more than one monomer constituent), and may be either linear or branched. If a heteropolymer derived from two monomer constituents is employed, the polyolefin may assume any copolymer chain arrangement, including those of a block copolymer or a random copolymer. The same holds true if the polyolefin is a heteropolymer derived from more than two monomer constituents. As examples, the polyolefin membrane may be formed of polyethylene (PE), polypropylene (PP), a blend of PE and PP, or multi-layered structured porous films of PE and/or PP.

In other examples, the porous separator 24 may be formed from another polymer chosen from polyethylene terephthalate (PET), polyvinylidene fluoride (PVdF), polyamides (Nylons), polyurethanes, polycarbonates, polyesters, polyetheretherketones (PEEK), polyethersulfones (PES), polyimides (PI), polyamide-imides, polyethers, polyoxymethylene (e.g., acetal), polybutylene terephthalate, polyethylenenaphthenate, polybutene, acrylonitrile-butadiene styrene copolymers (ABS), polystyrene copolymers, polymethylmethacrylate (PMMA), polyvinyl chloride (PVC), polysiloxane polymers (such as polydimethylsiloxane (PDMS)), polybenzimidazole (PBI), polybenzoxazole (PBO), polyphenylenes (e.g., PARMAX™ (Mississippi Polymer Technologies, Inc., Bay Saint Louis, Miss.)), polyarylene ether ketones, polyperfluorocyclobutanes, polytetrafluoroethylene (PTFE), polyvinylidene fluoride copolymers and terpolymers, polyvinylidene chloride, polyvinylfluoride, liquid crystalline polymers (e.g., VECTRAN™ (Hoechst AG, Germany), ZENITE® (DuPont, Wilmington, Del.), poly(p-hydroxybenzoic acid), polyaramides, polyphenylene oxide, and/or combinations thereof. In yet another example, the porous separator 24 may be chosen from a combination of the polyolefin (such as PE and/or PP) and one or more of the polymers listed above.

The porous separator 24 may contain a single layer or a multi-layer laminate fabricated from either a dry or wet process. For example, a single layer of the polyolefin and/or other listed polymer may constitute the entirety of the porous separator 24. As another example, however, multiple discrete layers of similar or dissimilar polyolefins and/or polymers may be assembled into the porous separator 24. In one example, a discrete layer of one or more of the polymers may be coated on a discrete layer of the polyolefin to form the porous separator 24. Further, the polyolefin (and/or other polymer) layer, and any other optional polymer layers, may further be included in the porous separator 24 as a fibrous layer to help provide the porous separator 24 with appropriate structural and porosity characteristics. A more complete discussion of single and multi-layer lithium ion battery separators, and the dry and wet processes that may be used to make them, can be found in P. Arora and Z. Zhang, “Battery Separators,” Chem. Rev., 104, 4424-4427 (2004).

Still other suitable porous separators 24 include those that have a ceramic layer attached thereto, and those that have ceramic filler in the polymer matrix (i.e., an organic-inorganic composite matrix).

Any appropriate electrolyte solution that can conduct lithium ions between the negative electrode 10 and the positive electrode 22 may be used in the lithium ion battery 30. In one example, the electrolyte solution may be a non-aqueous liquid electrolyte solution that includes a lithium salt dissolved in an organic solvent or a mixture of organic solvents. Skilled artisans are aware of the many non-aqueous liquid electrolyte solutions that may be employed in the lithium ion battery 30 as well as how to manufacture or commercially acquire them. Examples of lithium salts that may be dissolved in an organic solvent to form the non-aqueous liquid electrolyte solution include LiClO₄, LiAlCl₄, LiI, LiBr, LiSCN, LiBF₄, LiB(C₆H₅)₄, LiAsF₆, LiCF₃SO₃, LiN(FSO₂)₂, LiN(CF₃SO₂)₂, LiAsF₆, LiPF₆, and mixtures thereof. These and other similar lithium salts may be dissolved in a variety of organic solvents, such as cyclic carbonates (ethylene carbonate, propylene carbonate, butylene carbonate), linear carbonates (dimethyl carbonate, diethyl carbonate, ethylmethyl carbonate), aliphatic carboxylic esters (methyl formate, methyl acetate, methyl propionate), γ-lactones (γ-butyrolactone, γ-valerolactone), chain structure ethers (1,2-dimethoxyethane, 1-2-diethoxyethane, ethoxymethoxyethane, tetraglyme), cyclic ethers (tetrahydrofuran, 2-methyltetrahydrofuran, 1,3-dioxolane), and mixtures thereof.

As shown in FIG. 2, the lithium ion battery 30 also includes an interruptible external circuit 32 that connects the negative electrode 10 and the positive electrode 22. The lithium ion battery 30 may also support a load device 28 that can be operatively connected to the external circuit 32. The load device 28 receives a feed of electrical energy from the electric current passing through the external circuit 32 when the lithium ion battery 30 is discharging. While the load device 18 may be any number of known electrically-powered devices, a few specific examples of a power-consuming load device 28 include an electric motor for a hybrid vehicle or an all-electrical vehicle, a laptop computer, a cellular phone, and a cordless power tool. The load device 28 may also, however, be an electrical power-generating apparatus that charges the lithium ion battery 30 for purposes of storing energy. For instance, the tendency of windmills and solar panels to variably and/or intermittently generate electricity often results in a need to store surplus energy for later use.

The lithium ion battery 30 may also include a wide range of other components that, while not depicted here, are nonetheless known to skilled artisans. For instance, the lithium ion battery 30 may include a casing, gaskets, terminals, tabs, and any other desirable components or materials that may be situated between or around the negative electrode 10 and the positive electrode 22 for performance-related or other practical purposes. Moreover, the size and shape of the lithium ion battery 30, as well as the design and chemical make-up of its main components, may vary depending on the particular application for which it is designed. Battery-powered automobiles and hand-held consumer electronic devices, for example, are two instances where the lithium ion battery 30 would most likely be designed to different size, capacity, and power-output specifications. The lithium ion battery 30 may also be connected in series and/or in parallel with other similar lithium ion batteries to produce a greater voltage output and current (if arranged in parallel) or voltage (if arranged in series) if the load device 28 so requires.

The lithium ion battery 30 generally operates by reversibly passing lithium ions between the negative electrode 10 and the positive electrode 22. In the fully charged state, the voltage of the battery 30 is at a maximum (typically in the range 3.0 to 5.0V); while in the fully discharged state, the voltage of the battery 30 is at a minimum (typically in the range 1.0 to 3.0V). Essentially, the Fermi energy levels of the active materials in the positive and negative electrodes 22, 10 change during battery operation, and so does the difference between the two, known as the battery voltage. The battery voltage decreases during discharge, with the Fermi levels getting closer to each other. During charge, the reverse process is occurring, with the battery voltage increasing as the Fermi levels are being driven apart. During battery discharge, the external load device 28 enables an electronic current flow in the external circuit 32 with a direction such that the difference between the Fermi levels (and, correspondingly, the cell voltage) decreases. The reverse happens during battery charging: the battery charger forces an electronic current flow in the external circuit 32 with a direction such that the difference between the Fermi levels (and, correspondingly, the cell voltage) increases.

At the beginning of a discharge, the negative electrode 10 of the lithium ion battery 30 contains a high concentration of intercalated lithium while the positive electrode 22 is relatively depleted. When the negative electrode 10 contains a sufficiently higher relative quantity of intercalated lithium, the lithium ion battery 30 can generate a beneficial electric current by way of reversible electrochemical reactions that occur when the external circuit 32 is closed to connect the negative electrode 10 and the positive electrode 22. The establishment of the closed external circuit under such circumstances causes the extraction of intercalated lithium from the negative electrode 10. The extracted lithium atoms are split into lithium ions (identified by the black dots and by the open circles having a (+) charge) and electrons (e⁻) as they leave an intercalation host at the negative electrode-electrolyte interface.

The chemical potential difference between the positive electrode 22 and the negative electrode 10 (ranging from about 3.0 volts to about 5.0 volts, depending on the exact chemical make-up of the electrodes 10, 22) drives the electrons (e⁻) produced by the oxidation of intercalated lithium at the negative electrode 10 through the external circuit 32 towards the positive electrode 22. The lithium ions are concurrently carried by the electrolyte solution through the porous separator 24 towards the positive electrode 22. The electrons (e⁻) flowing through the external circuit 32 and the lithium ions migrating across the porous separator 24 in the electrolyte solution eventually reconcile and form intercalated lithium at the positive electrode 22. The electric current passing through the external circuit 32 can be harnessed and directed through the load device 28 until the level of intercalated lithium in the negative electrode 10 falls below a workable level or the need for electrical energy ceases.

The lithium ion battery 30 may be recharged after a partial or full discharge of its available capacity. To charge the lithium ion battery 30, an external battery charger is connected to the positive and the negative electrodes 22, 10, to drive the reverse of battery discharge electrochemical reactions. During recharging, the electrons (e⁻) flow back towards the negative electrode 10 through the external circuit 32, and the lithium ions are carried by the electrolyte across the porous separator 24 back towards the negative electrode 10. The electrons (e⁻) and the lithium ions are reunited at the negative electrode 10, thus replenishing it with intercalated lithium for consumption during the next battery discharge cycle.

The external battery charger that may be used to charge the lithium ion battery 30 may vary depending on the size, construction, and particular end-use of the lithium ion battery 30. Some suitable external battery chargers include a battery charger plugged into an AC wall outlet and a motor vehicle alternator.

To further illustrate the present disclosure, an example is given herein. It is to be understood that this example is provided for illustrative purposes and is not to be construed as limiting the scope of the disclosure.

### Example

A negative electrode was prepared according to the method disclosed herein.

First, a silicon powder (having an average particle size of 100 nm) was exposed to air for about 2 weeks. This process resulted in the oxidation of the surfaces of the silicon powder particles.

A pre-polymer solution was made with 4.12 g of toluene diamine and 10.93 g 3,3′,4,4′-benzophenonetetracarboxylic dianhydride in 85 g of NMP. The pre-polymer solution was stirred. 1 g of the pre-polymer solution (including about 0.15 g of poly(amic acid)) was measured out. This was added to additional NMP to form a solution of 3 wt % solids. A slurry was formed by adding 0.15 g of carbon black and 0.45 g of the oxidized silicon powder to the 3 wt % solids solution.

The slurry was cast on a current collector. The cast slurry was dried to remove any solvent and/or water. Drying was accomplished in a vacuum oven at 120° C. overnight. The dried, cast slurry was then exposed to heating. Heating was accomplished in a vacuum oven. The dried, cast slurry was exposed to 250° C. for about 2 hours, and then was exposed to 350° C. overnight. It is believed that heating resulted in the formation of the polyimide binder, at least some of which was bound to the oxidized silicon powder.

After heating was complete, the Example negative electrode was formed on the current collector. The electrode formulation was about 60 wt % of the oxidized silicon powder, about 20 wt % of the carbon black, and about 20 wt % of the polyimide binder. The silicon loading was about 1.01 mg/cm².

A Comparative negative electrode was also made. This electrode included about 60 wt % of the oxidized silicon powder, about 20 wt % of the carbon black, and about 20 wt % of carboxymethyl cellulose (CMC) as a binder material. The comparative negative electrode was also formed on a current collector.

The cycling performance of the Example negative electrode was tested and compared to the cycling performance of the Comparative negative electrode. The Example negative electrode and the Comparative negative electrode were evaluated using coin cells. Within the coin cells, the Example negative electrode and the Comparative negative electrode were paired with a metallic Li anode in 1M LiPF₆ (ethylene carbonate:dimethyl carbonate (EC:DEC) 1:1) plus 10 wt % fluorinated ethylene carbonate (FEC). The galvanostatic cycling performance of the Example negative electrode and the Comparative negative electrode was tested by cycling between 0.1V and 1V at a rate of C/10 at room temperature for up to 100 cycles.

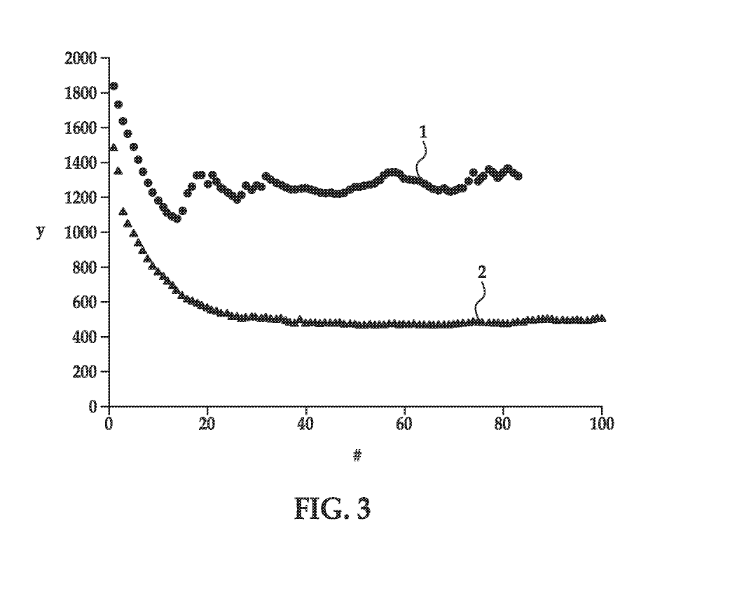

The cycling performance results are shown in FIG. 3. In particular, the specific capacity (mAh/g) is shown on the Y-axis (labeled Y) and the cycle number is shown on the X-axis (labeled #). The line for the Example negative electrode is labeled “1” and the line for the Comparative negative electrode is labeled “2”. The specific capacity results for the Example negative electrode is relatively over the various cycles, and are significantly improved compared to the specific capacity results for Comparative negative electrode. As such, the negative electrode including the polyimide binder bound to the oxidized silicon powder disclosed herein exhibited improved cycling stability.

The polyimide binder 16 bound directly to the oxidation layer 14 of the active material particles 13 disclosed herein is advantageously believed to improve the electronic and ionic conductivity in the negative electrode 10, improve the negative electrode integrity, and aid in the formation of the solid electrolyte interphase (SEI), which enhances the kinetics of the lithium intercalation.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

It is to be understood that the ranges provided herein include the stated range and any value or sub-range within the stated range. For example, a range from about 1 nm to about 20 μm should be interpreted to include not only the explicitly recited limits of from about 1 nm to about 20 μm, but also to include individual values, such as 5 nm, 1.5 μm, 10 μm, etc., and sub-ranges, such as from about 100 nm to about 10 μm; from about 75 nm to about 15 μm, etc. Furthermore, when “about” is utilized to describe a value, this is meant to encompass minor variations (up to +/−5%) from the stated value.

In describing and claiming the examples disclosed herein, the singular forms “a”, “an”, and “the” include plural referents unless the context clearly dictates otherwise.

While several examples have been described in detail, it will be apparent to those skilled in the art that the disclosed examples may be modified. Therefore, the foregoing description is to be considered non-limiting.

What is claimed is:

1. A negative electrode material, comprising:
an active material particle including:
a silicon core; and
an oxidation layer on a surface of the silicon core; and
a polyimide binder bound directly to the oxidation layer;
wherein an additional binding enhancing agent is excluded from the negative electrode material.

2. The negative electrode material as defined in claim 1 wherein the oxidation layer has a thickness ranging from about 0.1 nm to about 5 nm.

3. The negative electrode material as defined in claim 1 wherein anhydride groups of the polyimide binder and hydroxyl groups of the oxidation layer form an interfacial bond between the oxidation layer and the polyimide binder.

4. The negative electrode material as defined in claim 1, further comprising a conductive filler mixed with the active material particle and the polyimide binder.

5. A method for making a negative electrode material, the method comprising:
oxidizing a surface a silicon particle, thereby forming an active material particle including a silicon core and an oxidation layer on the silicon core;
adding a stoichiometric excess of a dianhydride to a diamine in a dipolar aprotic solvent to form a polyimide pre-polymer;
adding the active material particle to the polyimide pre-polymer to form a slurry;
depositing the slurry on a support; and
heat treating the deposited slurry, thereby forming a polyimide binder bound directly to the oxidation layer of the active material particle, whereby anhydride groups of the polyimide pre-polymer react with hydroxyl groups of the oxidation layer to form an interfacial bond directly between the oxidation layer and the polyimide binder without an additional binding enhancing agent.

6. The method as defined in claim 5 wherein oxidizing the surface of the silicon particle includes exposing the silicon particle to an environment containing oxygen for at least 1 hour.

7. The method as defined in claim 5 wherein after the depositing and prior to the heat treating, the method further comprises drying the deposited slurry to remove the dipolar aprotic solvent, wherein the drying takes place at a temperature ranging from about 60° C. to about 150° C.

8. The method as defined in claim 7 wherein the heat treating includes one of:
heating, under vacuum or an inert gas, at a temperature ranging from about 180° C. to about 400° C. for a time up to about 20 hours; or
applying a microwave and thermal treatment at a temperature ranging from about 180° C. to about 400° C. for a time up to about 20 hours.

9. The method as defined in claim 8 wherein the heating under vacuum or the inert gas involves ramping up the temperature over the time at preset intervals.

10. The method as defined in claim 5 wherein:
the dianhydride is selected from the group consisting of: 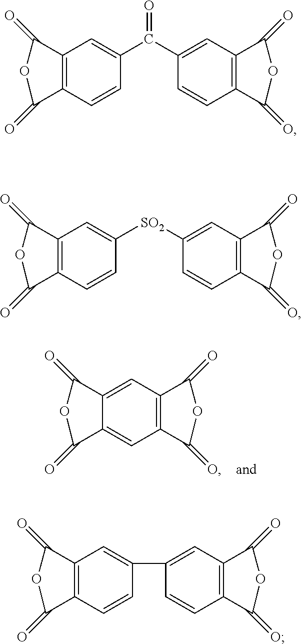
the diamine contains no more than 2 ether groups; and
the dipolar aprotic solvent is a Lewis base.

11. The method as defined in claim 5 wherein:
a conductive filler is included in the slurry;
the support is a current collector; and
prior to the heat treating, the method further comprises drying the deposited slurry to remove the dipolar aprotic solvent.

12. The method as defined in claim 11 wherein the slurry consists of:
from about 30 wt % to about 95 wt % of the active material particle;
from about 5 wt % to about 50 wt % of the conductive filler; and
from about 5 wt % to about 60 wt % of the polyimide pre-polymer.

13. A lithium ion battery, comprising:
a positive electrode including a lithium transition metal oxide based active material;
a negative electrode including:
a plurality of active material particles, each of the particles including:
a silicon core; and
an oxidation layer on a surface of the silicon core;
a polyimide binder bound directly to the oxidation layer of at least some of the plurality of active material particles; and
a conduction carbon is intermingled among the plurality of active material particles and the polyimide binder;
wherein an additional binding enhancing agent is excluded from the negative electrode material; and
a microporous polymer separator soaked in an electrolyte solution, the microporous polymer separator being disposed between the positive electrode and the negative electrode.

14. The lithium ion battery as defined in claim 13 wherein the oxidation layer of each of the active material particles has a thickness ranging from about 0.1 nm to about 5 nm.

15. The lithium ion battery as defined in claim 13 wherein anhydride groups of the polyimide binder and hydroxyl groups of the oxidation layer of at least some of the plurality of active material particles form an interfacial bond.

16. The lithium ion battery as defined in claim 13 wherein;
a loading of the active material particles in the negative electrode ranges from about 30 wt % to about 95 wt %;
a loading of the conductive filler in the negative electrode ranges from about 5 wt % to about 50 wt %; and
a loading of the polyimide binder in the negative electrode ranges from about 5 wt % to about 60 wt %.
